(19) United States
(12) Patent Application Publication
(10) Pub. No.: US 2026/0210017 A1
(43) Pub. Date: Jul. 23, 2026

(54) WATER-USING ELECTRICAL APPLIANCE AND METHOD FOR OPERATING A WATER-USING ELECTRICAL APPLIANCE

(71) Applicant: Miele & Cie. KG, Guetersloh (DE)

(72) Inventors: Werner STROTHOFF, Sassenberg (DE); Daniel EBKE, Bielefeld (DE); Rainer BICKER, Verl (DE); Sebastian OSSWALD, Winston-Salem, NC (US)

(21) Appl. No.: 19/572,389

(22) Filed: Mar. 19, 2026

Related U.S. Application Data
(62) Division of application No. 18/267,048, filed on Jun. 13, 2023.

(30) Foreign Application Priority Data
Dec. 14, 2020 (BE) 2020/05919

(51) Int. Cl. D06F 35/00; D06F 39/04; D06F 103/22

(52) U.S. Cl. CPC D06F 35/003; D06F 39/04; D06F 2103/22

(57) ABSTRACT

A water-bearing electrical apparatus having a water absorption element and an electrochemical cell which has a cathode arranged in a cathode space and an anode arranged in an anode space, which are spatially separated, wherein the electrochemical cell is designed to generate an alkaline partial solution in the cathode space and an acidic partial solution in the anode space when it contains a conductivity transmitter-containing medium and the DC voltage is applied to the anode and the cathode, and to heat a fluid located in the cathode and anode spaces when the AC voltage is applied to the anode and the cathode. A method includes generating an alkaline partial solution in the cathode space and an acidic partial solution in the anode space while applying DC voltage, applying AC voltage to heat fluid in the electrochemical cell, and conveying the alkaline partial solution into the water absorption element.

### RELATED APPLICATIONS

The present disclosure is a divisional application of U.S. Application 18/267,048, filed June 13, 2023, which claims priority to and the benefit of PCT Application PCT/EP2021/083525, filed on November 30, 2021, which claims priority to and the benefit of Belgium Application 2020/05919, filed on December 14, 2020, the entire contents of all of which are incorporated herein by reference.

### FIELD

The disclosure relates to a water-bearing electric apparatus and a method for operating a water-bearing electric apparatus. Particularly, the disclosure relates to a water-bearing electric apparatus having an electrochemical cell and a method for operating the water-bearing electric apparatus. The water-bearing electric apparatus is also referred to as the apparatus below for convenience.

### BACKGROUND

The installation of an electrochemical cell in a water-bearing electric apparatus reduces the installation space in the apparatus and increases the manufacturing costs.

### BRIEF SUMMARY

The disclosure thus addresses a problem of providing a water-bearing electric apparatus and a method for operating a water-bearing electric apparatus, which are inexpensive and require little installation space.

According to the disclosure, this problem is solved by a method and a washing machine having the features of the independent claims. Advantageous embodiments and developments of the disclosure can be found in the following dependent claims.

In addition to its cost effectiveness, the advantages achievable with the disclosure are that the electrochemical cell serves not only to produce electrolyte solutions in the form of the acidic partial solution and the alkaline partial solution, but also as a heating device. As a result, the apparatus does not require a separate, additional heating device, thus saving a component usually present in such apparatus. This further saves installation space and costs. Advantageously, a higher application temperature can be used for cleaning by the electrochemical cell despite the absence of a separately installed, additional heating device.

The disclosure relates to a water-bearing electric apparatus having

a water absorption element, and

an electrochemical cell having a cathode disposed in a cathode space and an anode disposed in an anode space, which are spatially separated, said electrochemical cell being selectively operable with direct voltage or alternating voltage, and being formed when it contains a medium containing a conductance transmitter and a DC voltage is applied to the anode and the cathode, to generate an alkaline partial solution in the cathode space and, separately therefrom, an acidic partial solution in the anode space, and when an AC voltage is applied to it, to heat a fluid located in the cathode and anode spaces.

The electrochemical cell has electrodes, i.e. an anode and a cathode, to which a DC voltage can be applied in order to subject an aqueous solution in it to electrolysis. By means of electrolysis, acidic and alkaline partial solutions can be produced separately from a conductivity transmitter-containing solution, such as salt-containing water, wherein the acidic partial solution is produced at the anode and the alkaline partial solution at the cathode. In order to produce the partial solutions separately, the electrochemical cell has a cathode space in which the cathode is accommodated and an anode space spatially separated therefrom in which the anode is arranged. These separately produced partial solutions represent effectively acting cleaning solutions that can be used for a cleaning process in the apparatus.

The electrochemical cell therefore makes it possible to generate an acidic partial solution and an alkaline partial solution separately from one another from a neutral starting material, such as the conductivity transmitter-containing solution, which can be heated, for example, to a predetermined application temperature by means of applying an AC voltage to the anode and the cathode. The fact that the alkaline partial solution and the acidic partial solution can be used one after the other and not simultaneously in the cleaning process increases the cleaning effect and hygienic advantages can be achieved. Thus, the alkaline partial solution has a higher cleaning effect, while the acidic partial solution can dissolve lime and keep components through which it flows free of lime, and in particular removes inorganic contamination. The acidic and alkaline partial solutions each have a higher acid and base capacity, respectively, and can achieve a better cleaning effect. The possibility of continuing to heat these partial solutions in the electrochemical cell can further increase their cleaning effect.

The electrical cell is designed to be operated with either DC or AC voltage. Preferably, the apparatus has a control unit with control electronics designed to switch from DC to AC voltage and vice versa before applying voltage to the electrochemical cell. The geometry with different electronic controlling further reduces installation space and costs. By reversing the polarity of the electrochemical cell from direct current to alternating current, electrochemical reactions can be performed as well as heating. To perform electrochemical reactions, water containing a conductivity sensor in the electrochemical cell is electrochemically split into the acidic partial solution and the alkaline partial solution by means of direct current. By means of applying AC voltage to the electrodes on the electrochemical cell, fluid inside it can be heated.

For example, the water-bearing electrical apparatus is a household apparatus that is used commercially or privately. Preferably, the apparatus is a washing machine or dishwasher. In the case of a washing machine, the water absorption element is the caustic container.

The conductor transmitter-containing medium is a medium designed to increase the conductance or electrical conductivity of water. The conductivity transmitter-containing medium is preferably one or more salts. The salt or salts may be a part of a detergent. For example, the apparatus is a washing machine and the objects are textiles in the form of laundry to be washed. Then the detergent may be a detergent commonly used for washing or treating laundry, such as heavy-duty detergent, mild detergent, fabric softener, stain remover, detergent, etc. In addition to the conductivity enhancer, the detergent continues to contain washing-active substances, thus further increasing the cleaning performance.

Preferably, the cathode space and the anode space are spatially separated from one another by means of an ion exchange membrane. This is a simple and cost-effective way of spatially separating the cathode space and the anode space and the partial solutions with different pH values located in them.

Preferably, the apparatus also has a chamber designed to store the acidic partial solution. The chamber serves as an intermediate storage facility for the acidic partial solution. This allows the acidic partial solution to be fed into the water absorption element at a later time, but the entire electrochemical cell is available, thus avoiding blocking the use of the anode space through the acidic partial solution present in it.

In a preferred embodiment, the apparatus has a metering unit designed to meter the conductivity transmitter-containing medium into the electrochemical cell. The dosing unit may have multiple chambers to further dose the detergent or different detergents into the electrochemical cell in a timed or delayed manner. Preferably, the dosing unit has a dosing pump designed to pump the detergent from the dosing unit into the electrochemical cell. The conductivity transmitter-containing medium is preferably liquid, for example a salt-containing liquid detergent.

Preferably, the apparatus has a circulating system designed to convey fluid from one area of the water absorption element through the cathode space and/or the anode space into a second area of the water absorption element. This allows the alkaline partial solution and/or the acidic partial solution to be circulated through the water absorption element and the electrochemical cell. This further improves the cleaning performance.

Preferably, the water-bearing electrical apparatus is connectable to a water connection and a control unit for the apparatus is configured to automatically control a supply of water from the water connection into the electrochemical cell. This means that a solution present in the electrochemical cell can still be diluted. The conductivity transmitter-containing medium can be supplied to the electrochemical cell as a concentrate that can be diluted. Furthermore, the alkaline partial solution and/or the acidic partial solution can also be further diluted as required. Alternatively or additionally preferably, the water-bearing electrical apparatus is connectable to the water connection and the control unit for the apparatus is configured to automatically control a supply of water from the water connection into the water absorption element.

The disclosure further relates to a method for operating a water-bearing electrical apparatus having a water absorption element and an electrochemical cell having a cathode disposed in a cathode space and an anode disposed in an anode space, which are spatially separated, wherein the method comprises the following steps

a) feeding a conductivity transmitter-containing medium into the electrochemical cell,

b) generating an alkaline partial solution in the cathode space and an acidic partial solution in the anode space by means of the conductivity transmitter-containing medium while applying DC voltage to the anode and the cathode,

c) applying AC voltage to the anode and cathode to heat fluid in the electrochemical cell; and

d) conveying the alkaline partial solution into the water absorption element in such a manner that cleaning of the water absorption element and/or objects located therein is performed.

Preferably, the steps are performed in the order indicated, wherein steps c) and d) may be performed simultaneously.

In step a), the conductivity transmitter-containing medium is fed into the electrochemical cell. Preferably, the conductivity transmitter-containing medium is supplied to the electrochemical cell in a predetermined amount. The conductivity transmitter-containing medium is preferably liquid and can be further diluted by adding water to the electrochemical cell if necessary. By means of the conductivity transmitter containing medium, the conductivity of the water can be adjusted. Advantageously, the conductivity or the conductance is adjusted in such a manner that the electrochemical cell can be operated under constant conditions.

In step b), the aqueous conductivity transmitter-containing solution is subjected to electrolysis, wherein the acidic partial solution in the anode space and the alkaline partial solution in the cathode space are electrochemically generated.

In step c), an AC voltage is applied to the anode and cathode to heat fluid in the electrochemical cell. Preferably, step c) is performed as soon as the chemical reaction in the electrolysis has proceeded, i.e. step b) has been completed.

In step d), cleaning of the water absorption element and/or objects therein is performed. For this purpose, in step d), the alkaline partial solution subjected to or undergoing step c) is preferably diluted with water, which is supplied to the electrochemical cell and/or the water absorption element. In step d), the alkaline partial solution and the water are preferably circulated. The flow causes the water in the electrochemical cell to swirl and the alkaline partial solution mixes with the water in the circuit. This can be realized by the circulating system. Due to the mixing of the concentrated alkaline partial solution in the electrochemical cell with the water, the conductivity of the solution decreases, thus, when the AC voltage from the mains is applied to the anode and the cathode on the electrochemical cell, a required heating power is generated. The conductivity transmitter-containing medium, which is supplied to the electrochemical cell in step a) according to the cell size, provides the required conductivity in step b) in the application concentration. This is higher than the maximum conductivity of drinking water, which means that the individual properties of the water used do not matter. By applying AC voltage to the anode and cathode, fluids present in the electrochemical cell, such as the alkaline partial solution, are heated.

In a preferred embodiment, following step d), step e) is performed in which the alkaline partial solution is pumped out of the water absorption element and conveyed out of the apparatus. After that, the water absorption element can be subjected to another cleaning or rinsing step.

Preferably, following step e), step f) is performed in which the acidic partial solution and optionally water are added to the water absorption element in such a manner that a further cleaning of the water absorption element and/or objects therein is performed. This allows acid-soluble contamination and deposits to be removed both from the water absorption element and from objects inside it.

Preferably, following step f), the optional water and acidic partial solution are pumped out of the water absorption element and conveyed out of the apparatus. Subsequently, the water absorption element and/or the electrochemical cell can be rinsed with water one or more times.

Preferably, water is added to the electrochemical cell before and/or during steps a), c) and/or d). Alternatively, the water can be supplied to the water absorption element in steps c) and/or d). This allows the alkaline partial solution to be diluted to a predetermined concentration.

In a preferred embodiment, fluid located in the electrochemical cell and the water absorption element is circulated in such a manner that it flows through the electrochemical cell and the water absorption element multiple times. This can further improve a cleaning effect if, for example, the alkaline partial solution or the acid partial solution are circulated.

In a preferred embodiment, after step b), the acidic partial solution is stored in a chamber of the apparatus. The acidic partial solution is temporarily stored outside the electrochemical cell for later use. This allows the entire electrochemical cell to be used in pumping the alkaline partial solution in the circuit. If the apparatus does not have a chamber, the delivery of the alkaline partial solution in the circuit can only be performed using the cathode space.

In a preferred embodiment, the conductivity transmitter-containing medium is a salt-containing liquid detergent. i.e., in addition to the conductivity enhancer, the medium also contains other detergent substances.

### BRIEF DESCRIPTION OF THE DRAWINGS

An embodiment of the disclosure is shown purely schematically in the drawings and is described in more detail below. It shows the components schematically and not to scale.

FIG. 1 shows a flow chart of a method according to the disclosure.

### DETAILED DESCRIPTION

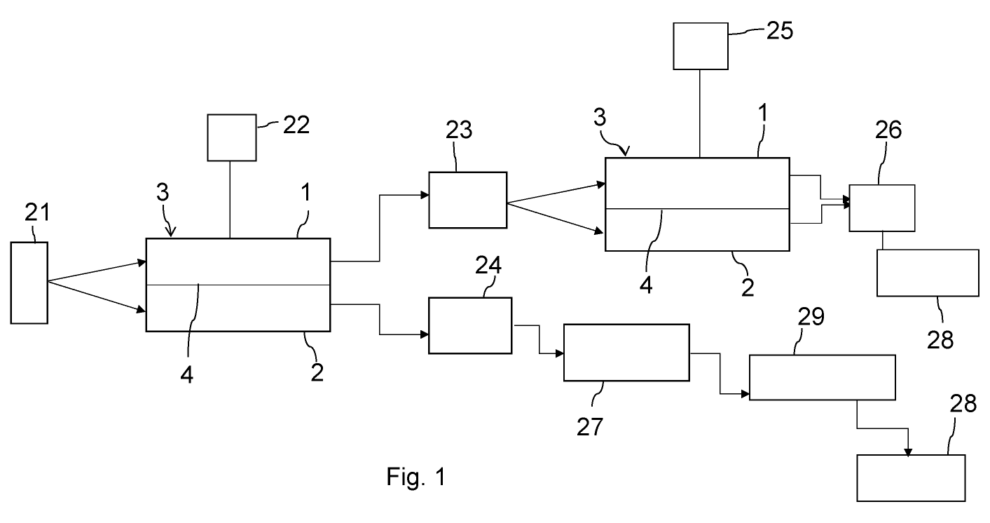

FIG. 1 shows a partial cross-sectional view of a washing machine according to the disclosure. In the method, a step 21 is first performed in which a conductivity transmitter-containing medium in the form of a salt-containing solution is provided in the electrochemical cell 3 by feeding, which has a cathode (not shown) in a cathode space 1 and an anode (not shown) in an anode space 2. The anode space 2 and the cathode space 1 are spatially separated by an ion exchange membrane 4. Subsequently, a step 22 is performed in which a DC voltage is applied to the anode and the cathode, thereby generating an alkaline partial solution in the cathode space 1 and an acidic partial solution in the anode space 2 by means of the conductivity transmitter-containing medium. In another step 24, the acidic partial solution is stored in a chamber (not shown), while the alkaline partial solution undergoes a step 23 in which it is diluted with water.

In a step 25 subsequently following step 23, an alternating voltage is applied to the anode and cathode on the electrochemical cell 3 to heat fluid present in the electrochemical cell 3, in particular the alkaline partial solution and the water supplied to it. In a step 26, which is subsequent or simultaneous to step 25, a cleaning step is performed either of the water absorption element itself and/or objects therein, wherein the heated alkaline partial solution is supplied to the water absorption element and circulated through the electrochemical cell and the water absorption element. In a step 28 following step 26, the alkaline partial solution and the water are pumped out of the water absorption element and removed from the apparatus. In a step 27, the acidic partial solution stored in the chamber in the step 24 is diluted with water. This step can be performed on and/or after storing. In a step 29 subsequently following step 27, a further cleaning step or a rinsing step is performed in which the acidic partial solution is supplied to the water absorption element. In a step 28 subsequently following step 29, the acidic partial solution and the water are pumped out of the water absorption element and removed from the apparatus.

List of reference signs

1 Cathode space

2 Anode space

3 Electrochemical cell

4 Ion exchange membrane

21 Feeding the conductivity transmitter-containing medium

22 Applying DC voltage

23 Dilution of the alkaline partial solution

24 Storing the acidic partial solution

25 Application of AC voltage

26 Cleaning

27 Pumping

28 Dilution of the further electrolyte solution

29 Cleaning or rinsing

1. A method for operating a water-bearing electrical apparatus having a water absorption element and an electrochemical cell having a cathode disposed in a cathode space and an anode disposed in an anode space, which are spatially separated, said method comprising the steps of:
a) feeding a conductivity transmitter-containing medium into the electrochemical cell;
b) generating an alkaline partial solution in the cathode space and an acidic partial solution in the anode space by way of the conductivity transmitter-containing medium while applying DC voltage to the anode and the cathode;
c) applying AC voltage to the anode and cathode to heat fluid in the electrochemical cell; and
d) conveying the alkaline partial solution into the water absorption element in such a manner that cleaning of the water absorption element and/or objects located therein is performed.

2. The method according to claim 1, wherein, following step d), step e) is performed in which the alkaline partial solution is pumped out of the water absorption element and conveyed out of the apparatus.

3. The method according to claim 2, wherein, following step e) a step f) is performed in which the acidic partial solution and optionally water are supplied to the water absorption element so that a further cleaning of the water absorption element and/or objects located therein is performed.

4. The method according to claim 3, wherein, following step f), the acidic partial solution and the optional water are pumped out of the water absorption element and conveyed out of the apparatus.

5. The method according to claim 1, wherein water is supplied to the electrochemical cell and/or the water absorption element before and/or during steps a), c) and d).

6. The method according to claim 1, wherein fluid located in the electrochemical cell and the water absorption element is circulated in the step d) in such a way that it flows several times through the electrochemical cell and the water absorption element.

7. The method according to claim 1, wherein the conductivity transmitter-containing medium is a salt-containing liquid detergent.

8. The method according to claim 1, wherein the electrochemical cell can be operated selectively with DC voltage or AC voltage and is configured to generate an alkaline partial solution in the cathode space and an acidic partial solution in the anode space by containing a conductivity transmitter-containing medium and applying the DC voltage to the anode and the cathode, and configured to heat a fluid located in the cathode and anode spaces by applying the AC voltage to the anode and the cathode.

9. The method according to claim 8, wherein the cathode space and the anode space are spatially separated from one another by means of an ion exchange membrane.

10. The method according to claim 8, further comprising a chamber designed to store the acidic partial solution.
